(19) United States
(12) Patent Application Publication
(10) Pub. No.: US 2026/0360177 A1
(43) Pub. Date: Nov. 12, 2026

(54) DATA EXTRACTION SYSTEM AND METHOD

(71) Applicant: AMADEUS S.A.S., Biot (FR)

(72) Inventors: Eldho ABRAHAM, Sydney (AU); Thomas Christopher Wolfgang LANDGREBE, Sydney (AU); Joshua MERRITT, Sydney (AU); Hristijan GJORGJIEVSKI, Melbourne (AU)

(21) Appl. No.: 19/100,240

(22) PCT Filed: Aug. 3, 2023
(86) PCT No.: PCT/EP2023/071575

§ 371 Date: Jan. 31, 2025

(30) Foreign Application Priority Data
Aug. 3, 2022 (IN) 202241044316

(51) Int. Cl. G06V 30/413; G06V 30/12; G06V 30/42

(52) U.S. Cl. CPC G06V 30/413; G06V 30/127; G06V 30/42

(57) ABSTRACT

The present invention is concerned with a data extraction system and method for extracting data from a document. The data extraction system comprises a data extraction application, the data extraction application including a trained document classification model and computer program code which when executed by a processor of an electronic device, causes the processor to: present a user interface on the electronic device instructing a user to capture an image of a document; submit the captured image of the document to the document classification model; receive from the document classification model a document category value for the document; process the document category value to select a next data extraction operation to be performed by the data extraction application; and launch the selected data extraction operation.

### FIELD

The present invention relates generally to a data extraction system and method. More specifically, the present invention relates to a system and method for controlling an electronic device to extract data from an official document (including passports and the like) for purposes such as identity verification and check-in automation.

### BACKGROUND

Any discussion of documents, devices, acts or knowledge in this specification is included to explain the context of the invention. It should not be taken as an admission that any of the material formed part of the prior art base or the common general knowledge in the relevant art on or before the priority date of the claims herein.

The travel industry is moving towards more automated and contactless procedures for customers to check into their chosen mode of transportation-such as an international flight. One approach to automated check-in involves the customer utilising a software application on their own device to scan the official document (such as a passport) that would otherwise be manually checked by a check-in agent. The application extracts data from the official document and transmits the data to the airline's check-in system for verification and actioning. In a process known as “biometric enrolment”, the data extraction application, in addition to extracting bibliographic data, captures biometric information; typically in the form of a facial scan taken from the customer's photograph in the official document. To perform identity verification, the customer can submit an additional digital photograph through the data extraction application that the check-in system compares against the recorded facial scan.

Biometric enrolment systems allow the customer to check into an international flight even before arriving at the airport, and then to board the flight after only being photographed by the airport security system. In this regard, the airport security system is able to verify the customer's identity and check-in status by comparing the pre-boarding photograph against the stored biometric information.

Current data extraction applications are somewhat cumbersome for the customer to use. Current applications also contain a large amount of on-screen instructions that customers may find frustrating and hard to follow.

### SUMMARY

The present invention aims to provide a data extraction system and method that are more convenient for the customer to use. According to the present invention, there are provided a data extraction system and method as defined in the claims.

In accordance with an aspect of the present disclosure, there is provided a data extraction system comprising a data extraction application, the data extraction application including a trained document classification model and computer program code which, when executed by a processor of an electronic device, causes the processor to: present a user interface on the electronic device instructing a user to capture an image of a document; submit the captured image of the document to the document classification model; receive from the document classification model a document category value for the document; process the document category to select a next data extraction operation to be performed by the data extraction application; and launch the selected data extraction operation.

The present disclosure provides a data extraction application that utilizes an on-device document classification machine learning model to classify an official document from a captured image thereof, and control a subsequent data extraction process based on the classification. The present disclosure not only relieves the traveller from manually entering the type of document into the application (such as by selecting the document type from a list), but also improves the efficiency of the overall data extraction operation.

Furthermore, by performing document classification client-side (using a local document classification model), processing time is improved in comparison to solutions that involve sending the captured document image to a backend server for processing. Client-side document classification also allows the application to perform necessary quality checks without transmitting data to the backend server.

Preferably, the processor selects the next data extraction operation from a set of data extraction operations, the set comprising: presenting a retry user interface instructing the user to capture another image of the document; performing optical character recognition on the document, presenting a manipulation user interface instructing the user to physically manipulate the document; and presenting a successful extraction user interface informing the user of a successful data extraction from the document.

Typically, the successful extraction user interface presents, on the electronic device, data extracted from the document.

The successful extraction user interface may include a confirmation user interface element manipulable by the user to confirm that data extracted from the document is correct.

Preferably, the manipulation user interface instructs the user to present another face of the document to the electronic device for capture. According to this embodiment, the computer program code may further cause the processor to perform an image capture routine on the another face of the document once captured by the electronic device. Alternatively, the computer program code further causes the processor to perform optical character recognition on the another face of the document once captured by the electronic device.

In other embodiments, the manipulation user interface instructs the user to present another part of the same face of the document to the electronic device for capture.

In some embodiments, the computer program code further causes the processor to: input features of the document classification model as heuristics to a heuristic-filtering algorithm; and execute the heuristic-filtering algorithm on the captured image prior to performing optical character recognition on the captured image.

The features of the document classification model typically include the presence of a machine-readable zone and the structure of the machine readable zone.

In preferred embodiments, the data extraction application and the document classification model are comprised in a web application that is executable by a web browser installed on the electronic device.

In accordance with another aspect of the present disclosure, there is provided a method for extracting data from a document, the method comprising: delivering a data extraction application and a trained document classification model to an electronic device; the data extraction application presenting a user interface on the electronic device instructing a user to capture an image of a document; the data extraction application submitting the captured image of the document to the document classification model; the data extraction application receiving from the document classification model a document category value for the document; the data extraction application processing the document category value to select a next data extraction operation to be performed by the data extraction application; and the data extraction application launching the selected data extraction operation.

In one embodiment, the data extraction application selects the next data extraction operation from a set of data extraction operations, the set comprising: presenting a retry user interface instructing the user to capture another image of the document; performing optical character recognition on the document, presenting a manipulation user interface instructing the user to physically manipulate the document; and presenting a successful extraction user interface informing the user of a successful data extraction from the document.

Preferably, the successful extraction user interface presents, on the electronic device, data extracted from the document.

The successful extraction user interface may include a confirmation user interface element manipulable by the user to confirm that data extracted from the document is correct.

Optionally, the manipulation user interface instructs the user to present another face of the document to the electronic device for capture.

In other embodiments, the data extraction application performs an image capture routine on the another face of the document once captured by the electronic device.

In other embodiments, the data extraction application performs optical character recognition on the another face of the document once captured by the electronic device.

The manipulation user interface typically instructs the user to present another part of the same face of the document to the electronic device for capture.

Preferably, the document extraction application: inputs features of the document classification model as heuristics to a heuristic-filtering algorithm; and executes the heuristic-filtering algorithm on the captured image prior to performing optical character recognition on the captured image.

The features of the document classification model may include the presence of a machine-readable zone and the structure of the machine readable zone.

Preferably, the data extraction application and the document classification model are comprised in a web application that is executable by a web browser installed on the electronic device.

### BRIEF DESCRIPTION OF THE DRAWINGS

Embodiments will now be described by way of example only, with reference to the accompanying drawings in which:

FIG. 1 is a schematic representation of a computing environment in which aspects of the present invention can be implemented;

FIG. 2 is a block diagram illustrating the modules of a Data Extraction Application in accordance with an embodiment of the present invention;

FIG. 3 is a flow chart illustrating a data extraction and transmission process performed by a Data Extraction Application in accordance with an embodiment of the present invention;

FIG. 4 is an illustration of a User Interface generated by the Data Extraction Application in accordance with an embodiment of the present invention;

FIG. 5 is an illustration of a Verify Details User Interface generated by the Data Extraction Application in accordance with an embodiment of the present invention;

FIG. 6 is a flow chart illustrating a Card Flip Operation performed by the Data Extraction Application in accordance with an embodiment of the present invention;

FIG. 7 is an illustration of a Card Flip User Interface generated by the Data Extraction Application in accordance with an embodiment of the present invention;

FIG. 8 is an illustration of Lighting Compensation and Binarization Operations performed by the Data Extraction Application in accordance with an embodiment of the present invention;

FIG. 9 is an illustration of CCL and Clustering Operations performed by the Data Extraction Application in accordance with an embodiment of the present invention;

FIG. 10 is an illustration of Heuristics Filtering Operations performed by the Data Extraction Application in accordance with an embodiment of the present invention;

FIG. 11 illustrates an example homography calculation performed by the Data Extraction Application in accordance with an embodiment of the present invention; and

FIG. 12 is a block diagram of a computer system suitable for implementing an embodiment of the present invention.

### DETAILED DESCRIPTION

In the following detailed description, reference is made to accompanying drawings which form a part of the detailed description. The illustrative embodiments described in the detailed description and depicted in the drawings, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

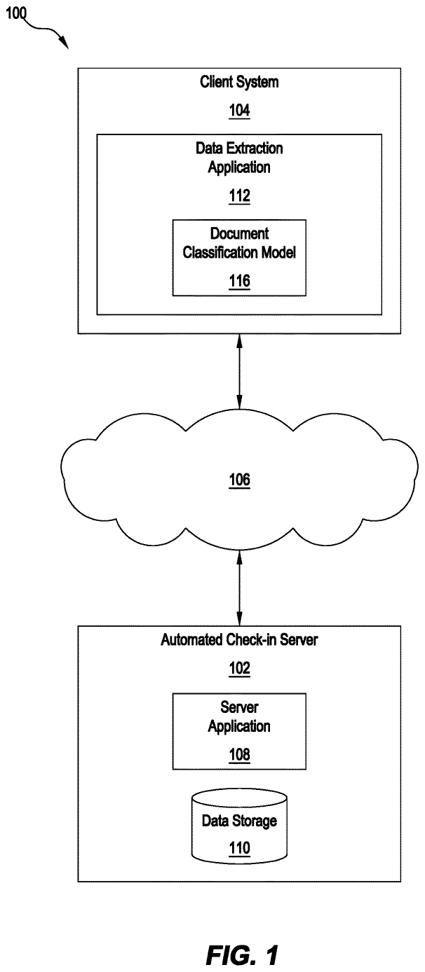

FIG. 1 illustrates a computing environment 100 in which aspects of the present invention are implemented. The environment 100 is a networked environment comprising an Automated Check-In Server 102 in communication with a Client System 104 over one or more communication networks 106. Aspects of the computer processing described below are performed by a Server Application 108 executing on the Automated Check-In Server 102 and a Data Extraction Application 112 executing on the Client System 104.

Automated Check-In Server 102 further includes a Data Storage 110 on which data collected by the Data Extraction Application 112 and transmitted to the Automated Check-In Server 102 is stored. Data storage 110 is typically a storage medium such as a hard drive (or collection of hard drives). A database management system (not shown) executing on Automated Check-In-Server 102 implements a database on Data Storage 110 for storing and retrieving data.

Automated Check-In Server 102 has been illustrated as a single system. Automated Check-In Server 102 can, however, be a scalable server system comprising multiple nodes which can be commissioned/decommissioned based on processing demands. Typically, server systems are server computers that provide greater resources (e.g. processing, memory, network bandwidth) in comparison to client systems.

In the illustrated embodiment, Data Storage 110 is illustrated as part of the Automated Check-In Server. However, the Data Storage 110 could be a separate system in operative networked communication with the Automated Check-In Server 102. For example, the Data Storage could be a networked-attached storage device, an entirely separate storage system accessed via a database management system, or any other appropriate data storage mechanism.

As described in further detail below, the Server Application 108 performs various operations in response to commands received from (and initiated at) the Data Extraction Application 112. As such, when executed by the Automated Check-In Server 102, the Server Application 108 configures the Automated Check-In Server 102 to provide server-side functionality to the Data Extraction Operation. To provide this functionality, the Server Application 108 comprises one or more suitable application programs, libraries, or other software infrastructure.

Where the Data Extraction Application 112 is a web application that is executed by a web browser, the Server Application 108 will typically be, or interact with, a web server such as a server implemented with the node.js runtime environment. Where the Data Extraction Application 112 is a native application of the Client System 104, the Server Application 108 will typically be, or interact with, an application server. Automated Check-In Server system 102 may be provided with both web server and application server applications to enable it to serve both web browser and native client applications.

The Automated Check-In Server 102 and Client System 104 communicate data between each other either directly or indirectly through one or more Communications Networks 106. Communications network 106 may comprise a local area network (LAN), a public network (such as the Internet), or a combination of networks.

While only one Client System 104 is depicted in environment 100, a typical environment would typically include many more client systems served by the Automated Check-In Server 102.

While Client System 104 can be any type of computer system, including a desktop computer or laptop computer, it will more commonly be a smartphone or a tablet device with an integrated or connected camera. When executed by the Client System 104, the Data Extraction Application 112 configures the Client System 104 to provide client-side data extraction functionality and interact with the Automated Check-In Server 102.

As noted above, the Data Extraction Application 112 may be provided to the Client System 104 as a web application that is executed by a general web browser application (such as Chrome, Edge, Safari or the like) that is installed thereon. When provided as a web application, the Data Extraction Application 112 accesses the Server Application 108 via an appropriate uniform resource locator (URL) and communicates with the Server Application 108 via general world-wide-web protocols (e.g. http, https, ftp) and application programming interfaces (APIs) (e.g. REST APIs). Alternatively, when the Data Extraction Application 112 is a native application, it is typically programmed to communicate with the Server Application 108 using defined API calls.

A given Client System 104 may have more than one client application 112 installed thereon, for example both a general web browser application and a dedicated programmatic client application.

As discussed below, a web application implementation can have certain advantages over a native application implementation. In particular, the web application implementation can be more easily integrated with the backends of the various automated check-in systems that different airlines and airports offer.

As discussed below, the Data Extraction Application 112 utilizes a Document Classification Model 116 to perform data extraction operations. The Document Classification Model 116 is a model that results from training a machine learning network such as a convolutional neural network. The particular training performed to build the Document Classification Model 116 is discussed below.

The Server Application 108 preferably provides the Document Classification Model 116 to the Client System 104 contemporaneously with the code of the Data Extraction Application 112. For example, when the Data Extraction Application 112 is a web application, the Server Application 108 transmits the Document Classification Model 116 to the Client System 104 along with the Javascript code of the Data Extraction Application 112. Providing the Document Classification Model 116 to the Client System 104 allows the Data Extraction Application 112 to perform inferencing locally, which speeds processing time and improves reliability.

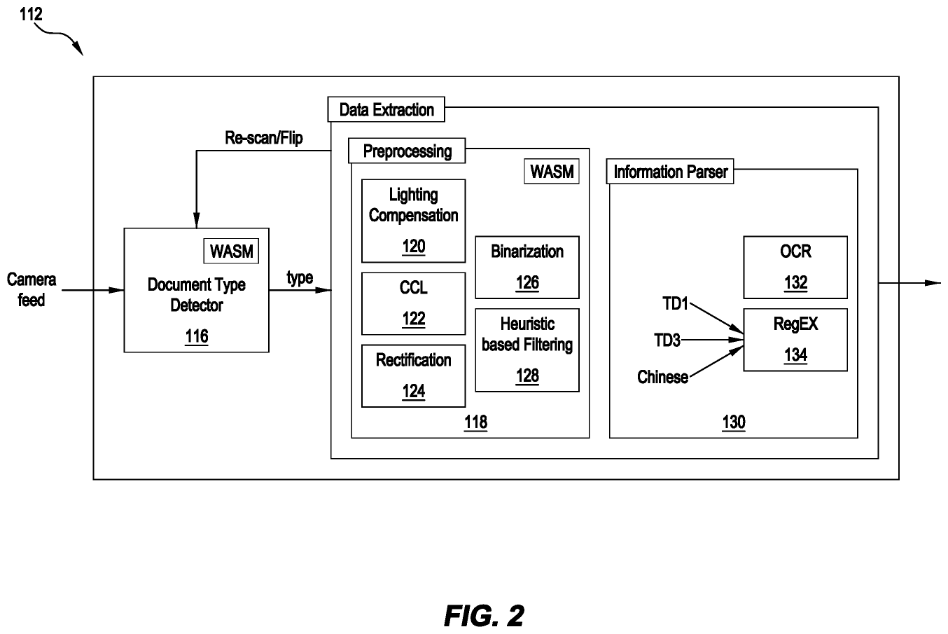

The Data Extraction Application 112 includes a number of software modules which are described below by reference to FIG. 2.

The Data Extraction Application 112 utilizes the Document Classification Model 116 to perform inferencing on an image of an official document. As described below, the customer operates the camera 120 of the Client System 104 to capture an image of an official document typically following instructions that the Data Extraction Application 112 provides on the display of the Client System. The Document Classification Model 116 is trained to recognise different types of official document.

For example, the “Machine Readable Travel Documents” specification (Doc 9303), maintained by the International Civil Aviation Organization promulgates standards pertaining to Machine Readable Travel Documents (MRTD) to ensure global interoperability. MRTDs encode much of their relevant data in optical character recognition (OCR) format. The OCR-encoded information is located in a region of the travel document known as the Machine-Readable Zone (MRZ). According to Doc 9303, there are three standardized document types (being TD1, TD2 and TD3) that are defined by reference to the position of the MRZ within the document.

The Document Classification Model 116 is trained to recognise documents that do not necessarily comply with the Doc 9303 standard. For example, the Document Classification Model 116 is trained on (and can thus recognise) Chinese identity cards with a one-row MRZ.

The TD1 is mostly used in identity cards. The MRZ is on the reverse side of a TD1 document, which results in the necessity to capture both the front and the back of the document when performing data extraction. Each issuing country can add optional content to the document; usually added on the reverse side of the document adjacent to the MRZ.

The MRZ of a TD1 document spans 3 lines, each of 30 characters. Standardised data elements are included in the MRZ, along with one or more check digits (for data verification) and any optional information.

A TD2 document is also used for identity cards and is larger, in terms of area, than a TD1 document. The MRZ is on the front face of a TD2 document and comprises 2 lines, each of 35 characters. As with a TD1 document, the MRZ of a TD2 document includes standardised data elements, check digit/s and optional information.

The TD3 document is used in most travel passports issued by the majority of issuing agencies. Although TD3 documents are typically in the form of a booklet, the document includes a card with the information presented thereon. The TD3 document is a larger size compared to a TD1 document, and includes a 2-line MRZ, each of 44 characters. As with TD1 and TD2 documents, the MRZ of a TD3 document includes standardised fields, check digit/s and optional information. TD3 documents also include a photograph of the document's owner located in the Visual Inspection Zone (VIZ) of the document.

Using the training dataset and algorithms described below, the exemplified Document Classification Model 116 is capable of predicting whether an image of a document is of one of the following categories:
The front of a TD1 document;
The back of a TD1 document;
A TD3 document;
A Chinese Identity document.

The Document Classification Model 116 outputs the result of a prediction operation as a data value of the type: document category. The exemplified document categories are TD1_Front, TD1_Back, TD3 and Chinese. Those skilled in the art will appreciate that with appropriate training, the Document Classification Model 116 can function to predict documents of other categories.

The Document Classification Model 116, like the Data Extraction Application 112 is distributed to the Server Application 108 (for eventual serving to the Client System 104) in the form of portable pre-compiled binary-code, such as WebAssembly (or WASM).

The Data Extraction Application 112 further includes a Preprocessing module 118. Preprocessing Module 118 includes computer-executable code for preprocessing a document image prior to performing OCR on MRZ text. As described below, the Preprocessing Module 118 includes a number of sub-modules that allow the Data Extraction Application 112 to locate an MRZ in a document image. In the exemplified embodiment, these sub-modules are:
Lighting Compensation Module 120;
Connected-Component Labelling (CCL) Module 122;
Rectification Module 124;
Binarization Module 126; and
Heuristic-based Filtering Module 128.

The Data Extraction Application 112 further includes an Information Parser Module 130. Information Parser Module 130 includes computer-executable code for performing OCR on the text of the MRZ that the Perprocessing Module 118 identifies. In addition to an OCR Module 132, the Information Parser Module 130 includes a Regular Expression (Regex) Module 134 for processing the OCR text that the OCR Module 130 generates. As described below, the Regex Module 134 utilizes the document category value when processing the OCR text.

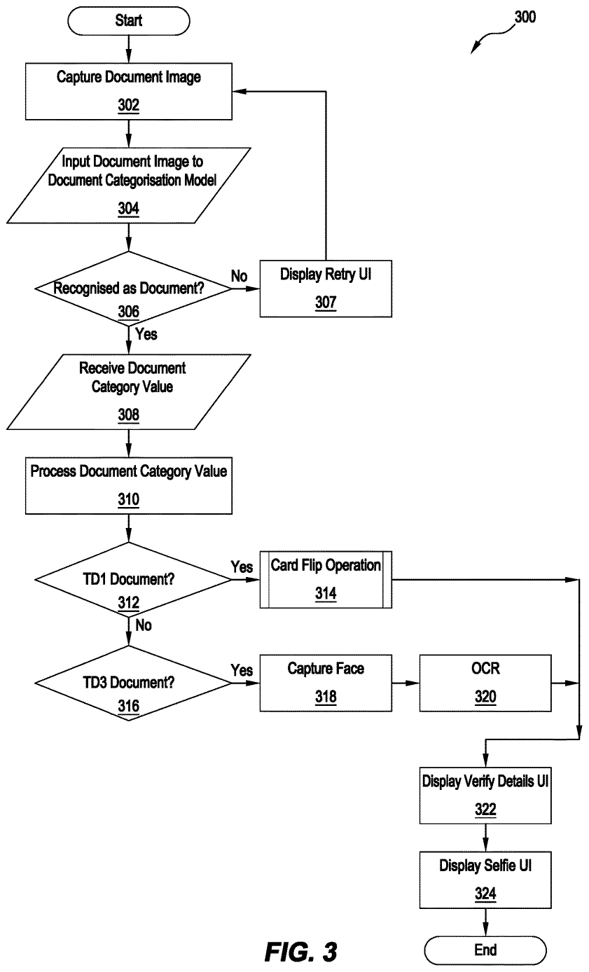

FIG. 3 conceptually depicts one embodiment of a computer-executable process 300 that the Data Extraction Application 112 performs to allow a traveller to scan an official document and transmit extracted data to an Automated Check-In Server 102.

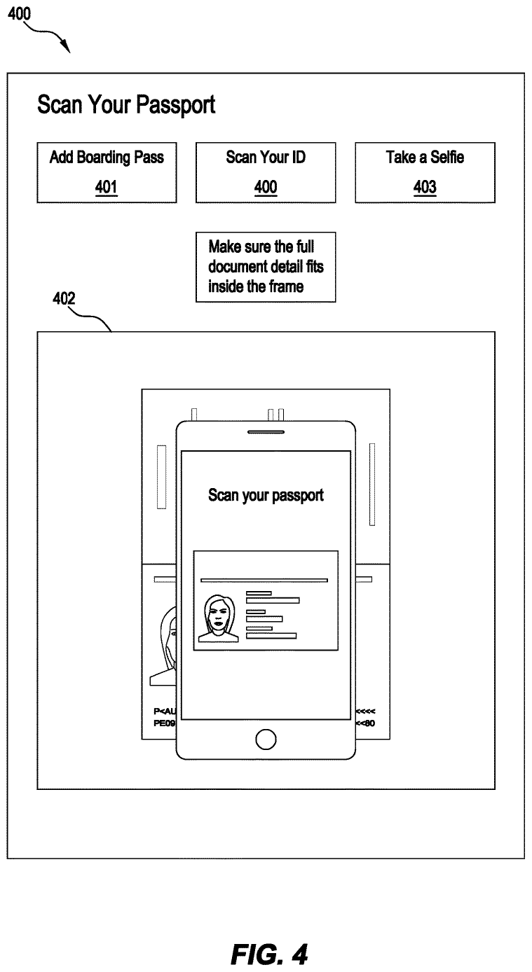

The process commences at step 302, at which the Data Extraction Application 112 captures an image of the official document using the Client System 104's camera. In the exemplified embodiment, the Data Extraction Application 112 presents a user interface 400 (FIG. 4) on the display of the Client System 104 that includes textual and graphical instructions to the traveller to manipulate the camera so as to locate the official document in a frame 402 of the user interface. User Interface 400 also includes a Button 404 that the traveller operates to add a boarding pass to the data that is transmitted to the Automated Check-In Server 101.

Upon the Data Extraction Application 112 detecting the traveller taking a photograph of the official document, the proceeds to step 304, at which the Data Extraction Application 112 inputs the captured document image to the Document Classification Model 116.

At step 306, the Document Classification Model 116 performs an initial inferencing operation on the captured image to determine if the Model recognises the image as one of an official document. In the event that the Document Classification Model 116 does not recognise the image as an official document, the process proceeds to step 307, at which the Data Extraction Application displays a Retry User Interface on the Client System. The Retry User Interface can be similar (or identical) in appearance to the User Interface 400 by including textual and graphical instructions to assist the traveller to capture an image of the official document (step 302).

The method proceeds to step 308 in the event that the Document Classification Model 116 recognises the captured image as an image of an official document. At step 308, the Document Classification Model 116 performs inferencing on the image to classify the image into a document category and assign an appropriate document category value to the document. The Data Extraction Application 112 receives this document category value from the Document Classification Model 116.

At step 310, the Data Extraction Application 112 processes the document category value.

At step 312, the Data Extraction Application 112 performs a determination of whether the document category value indicates that the document is a TD1 document.

In the event that the document is determined to be a TD1 document, the process proceeds to step 314, at which the Data Extraction Application 112 performs a Card Flip Operation. The Card Flip Operation that the Data Extraction Application 112 performs is described below.

In the event that the document is determined not to be a TD1 document, the process proceeds to step 316, at which the Data Extraction Application 112 performs a determination of whether the document category value indicates that the document is a TD3 document.

The process terminates in the event that the Data Extraction Application 112 determines that the document is not a TD3 document.

In the event that the Data Extraction Application 112 determines that the document is a TD3 document, the process proceeds to step 318, at which the Data Extraction Application 112 performs an operation to capture the face of the TD3 document. As discussed above, operation 318 involves the Data Extraction Application 112 pre-processing the image to identify an MRZ therein. Operation 318 also involves the Data Extraction Application 112 extracting the traveller's photograph from the document.

The process then proceeds to step 320, at which the Data Extraction Application 112 performs optical character recognition (OCR) on the MRZ so as to capture the text in a suitable format (such as ASCII text).

The method then proceeds to step 322. The method also proceeds to step 322 after the Data Extraction Application 112 performs the Card Flip Operation on a TD1 document.

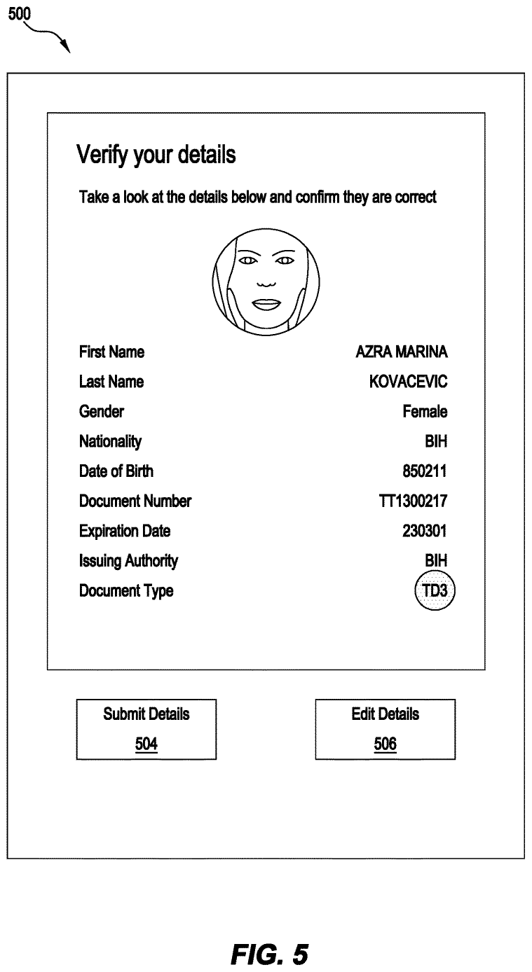

At step 322, the Data Extraction Application 112 displays a Verify Details User Interface on the display of the Client System 104. An example Verify Details User Interface 500 is illustrated in FIG. 5. The Verify Details User Interface 500 lists the data that the Data Extraction Application 112 extracted from the official document. In the exemplified embodiment, the extracted data comprises the passenger's: First Name, Last Name, Gender, Nationality, Date of Birth, Document Number, Expiration Date, Issuing Authority and Document Type. As noted above, apart from the Document Type, the data is extracted from the MRZ using the OCR operation. The extracted data also includes the traveller's photograph 502 from the official document.

The Verify Details User Interface 500 includes a Submit Details Button 504 that the traveller operates (in the event that the extracted data is correct) to have the Data Extraction Application 112 transmit the extracted data to the Automated Check-In Server 102. The Verify Details User Interface includes an Edit Details Button 506 that the traveller operates to manually edit any incorrect extracted data.

After displaying the Verify Details User Interface 500, the method proceeds to step 324, at which the Data Extraction Application displays a Selfie Capture User Interface on the display of the Client System 104. An example of a Selfie Capture User Interface is illustrated in FIG. 4, in the form of a “Take a Selfie Button 404”. Upon operating Button 404, the Data Extraction Application 112 instructs the user to take a selfie (or select an existing photograph) and transmits the selfie to the Automated Check-In-Server 102. As noted above, the Server Application 108 utilises the submitted selfie to perform identify verification by comparing the selfie with the photograph 502 from the official document.

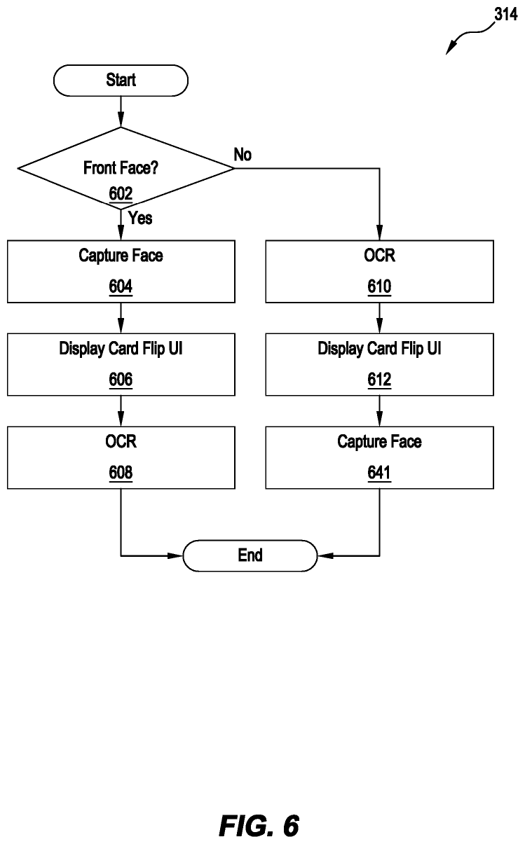

An example of a Card Flip Operation 314 is illustrated by reference to FIG. 6. As noted above, the Data Extraction Application 112 performs a Card Flip Operation when the document category value indicates that the document is a TD1 document.

The process 314 commences at step 602, at which the Document Classification Model 116 performs inferencing on the document image and determines whether the image is of the front face of the TD1 document. If the Document Classification Model determines that the image is of the front face of the document, the process proceeds to step 604, at which the Data Extraction Application 112 performs a Capture Face Operation.

In the case of a TD1 document, the Capture Face Operation 604 involves capturing an image of the traveller's photograph in the document.

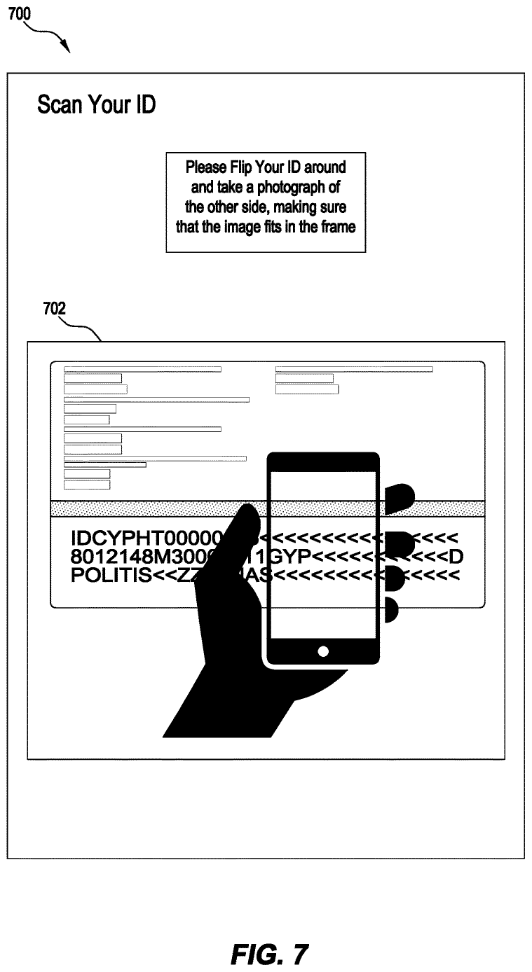

The process then proceeds to step 606, at which the Data Extraction Application 112 displays a Card Flip User Interface on the display of the Client System 104. An example of a Card Flip User Interface 700 is illustrated in FIG. 7. Interface 700 includes textual and graphical instructions to the traveller to flip the document over and take a photograph of the other side. As with Interface 400, Interface 700 includes a Frame 702 in which the traveller is instructed to locate the image of the ID document.

After the traveller takes the photograph of the other side of the ID document, the process proceeds to step 608, at which the Data Extraction Application 112 performs OCR on the captured image. In regards to a TD1 document, as noted above, the MRZ is on the rear face of the document.

In the event that the Document Classification Model 116 determines that the image is of the rear face of the TD1 document, the process proceeds to step 610, at which the Data Extraction Application 112 performs OCR on the captured image, as per. step 608.

The process then proceeds to step 612, at which the Data Extraction Application 112 displays the Card Flip User Interface on the display of the Client System 104, as per step 606.

The process then proceeds to step 614, at which the Data Extraction Application 112 performs a Capture Face operation, as per step 604.

Certain data augmentation techniques were utilised to train a neural network into a Document Classification Model that could be deployed as a web application and reliably classify official documents client-side. In particular, an initial data set of images of TD1-Front, TD1-Back and TD3 documents were augmented using background randomization and scan randomisation.

A training data set of Chinese Identification Documents was generated by performing row augmentation using interpolation from a set of TD3 sample documents. This resulted in a set of training examples with the visual characteristics of a TD3 document, but a single row MRZ.

The augmented training set of TD3 documents trained the neural network to recognise a document with a photograph and a 3-row MRZ.

Similarly, the augmented training set of TD1-Back images trained the neural network to recognise a 2-row MRZ.

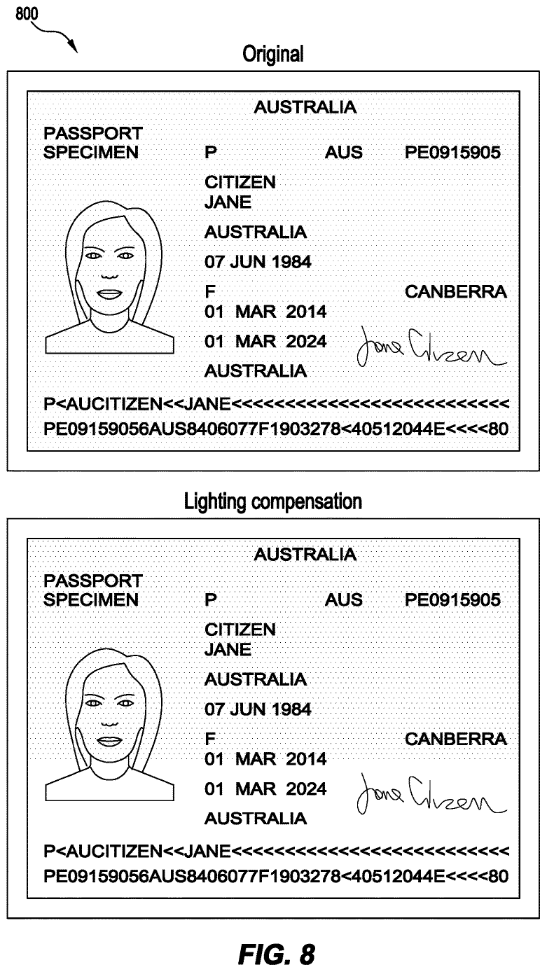

An example of the Lighting Compensation and Binarization operations performed on an image prior to OCR is illustrated in FIG. 8. The operations involve performing ROI localization relative to a detected face.

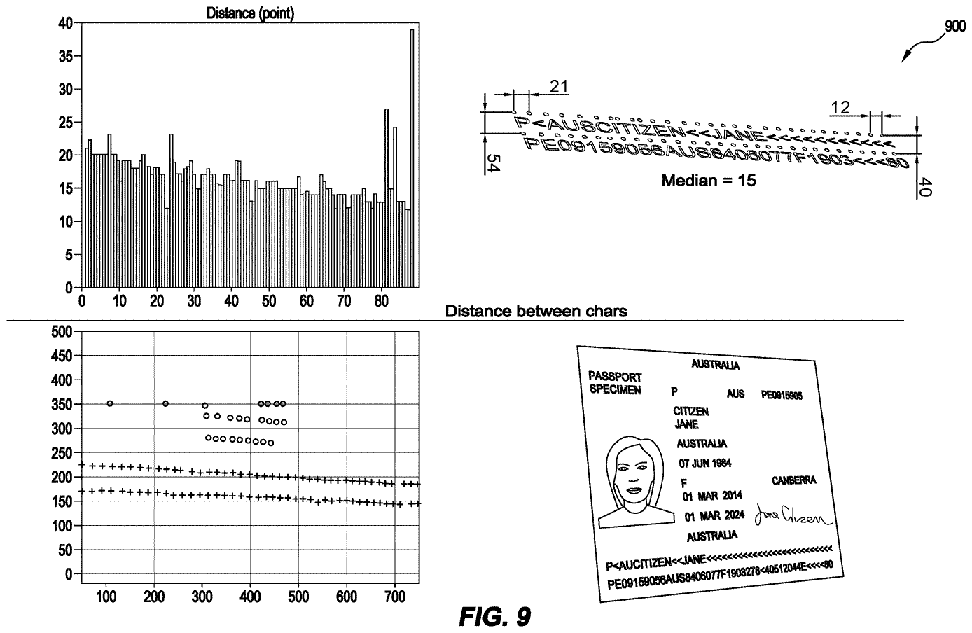

An example of the CCL and Clustering operations performed on an image prior to OCR is illustrated in FIG. 9. In preferred embodiments, these operations exploit the property of MRZ symmetry.

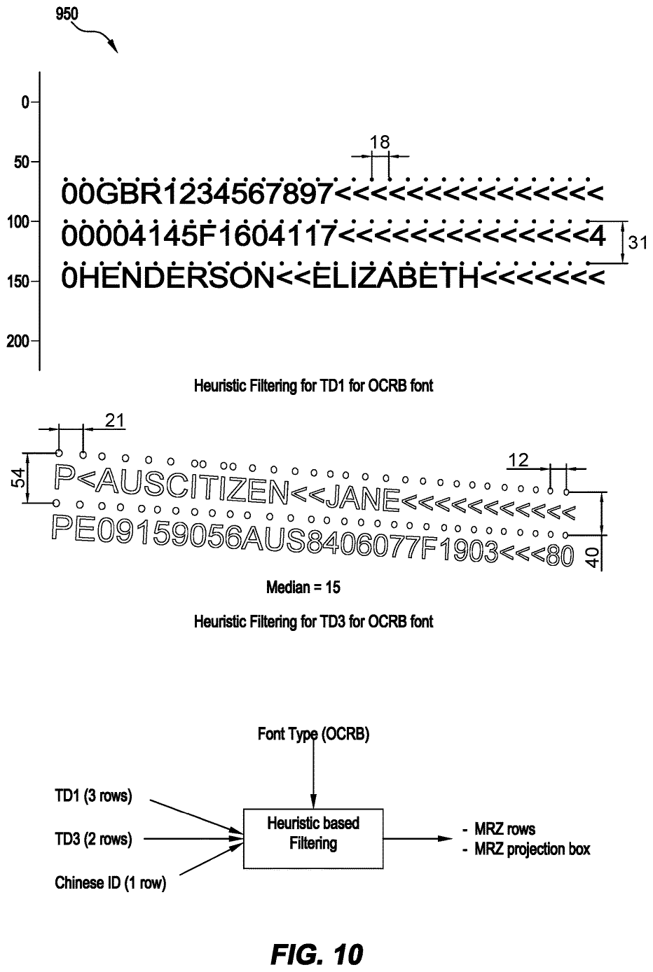

An example of the Heuristics Filtering operations 950 performed on an image prior to OCR is illustrated in FIG. 10. Heuristics Filtering is shown for both a TD1 document and a TD3 document, both with an MRZ in the OCRB font.

In the illustrated embodiment, the detected characters and their corresponding clusters are filtered by tuning the following characteristics of the MRZ and its OCRB font:
characters per row;
pixel per character;
space per character;
distance between characters;
distance between MRZ rows; and
MRZ width and height.

In the illustrated embodiment, the filtering algorithm involves:
sorting the filtered clusters based on the number of characters in the cluster;
determining the median spacing between the characters on the largest cluster; filtering out characters in all other clusters based on the computed median spacing;
computing a projection box of each cluster (potential MRZ row);
positioning the clusters in order (top, middle or bottom row) based on the projection box position; and
computing the projection box of the entire MRZ region by taking the extreme points in all four corners (Top Left, Top Right. Bottom Left, Bottom Right). This projection box can then be used for rectification using a homography matrix

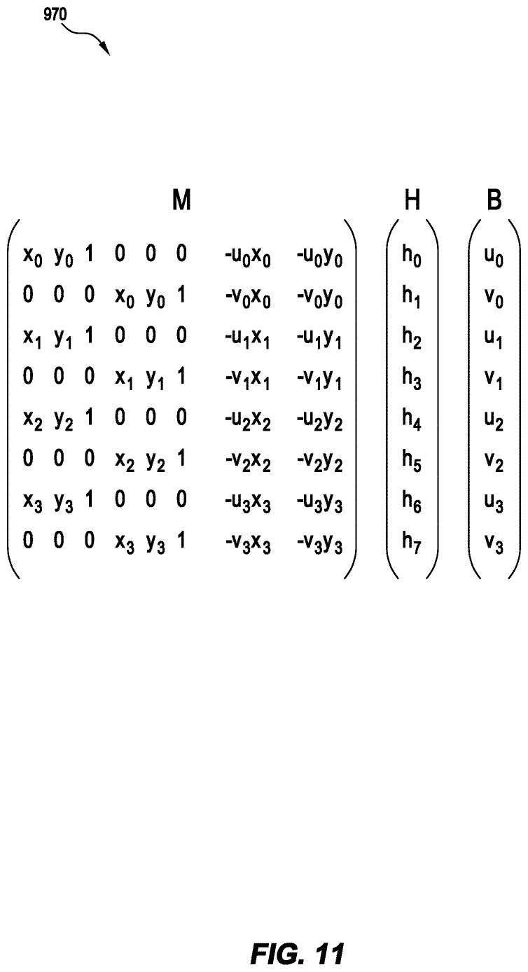

An example of a homography calculation 970 is illustrated in FIG. 11. As a skilled addressee will appreciate, homography calculations exploit the fact that any two images of the same planar surface in space are related by a homography.

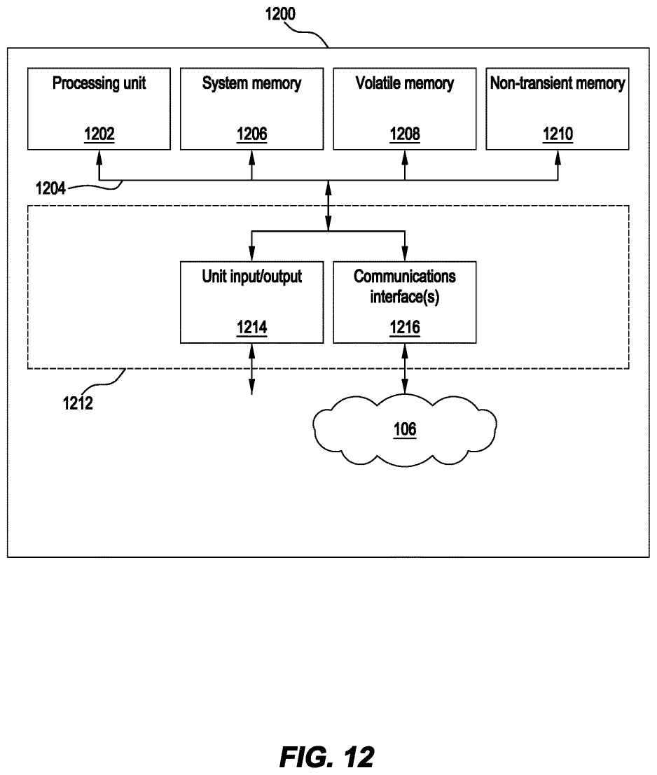

FIG. 12 provides a block diagram of a computer processing system 1200 configurable to implement embodiments and/or features described herein. System 1200 is a general purpose computer processing system. It will be appreciated that FIG. 12 does not illustrate all functional or physical components of a computer processing system. For example, no power supply or power supply interface has been depicted, however system 1200 will either carry a power supply or be configured for connection to a power supply (or both). It will also be appreciated that the particular type of computer processing system will determine the appropriate hardware and architecture, and alternative computer processing systems suitable for implementing features of the present disclosure may have alternative components to those depicted.

Computer processing system 1200 includes at least one processing unit 1202. The processing unit 1202 may be a single computer processing device (e.g. a central processing unit, graphics processing unit, or other computational device), or may include a plurality of computer processing devices. In some instances all processing will be performed by processing unit 1202, however in other instances processing may also be performed by remote processing devices accessible and useable (either in a shared or dedicated manner) by the system 1200.

Through a communications bus 1204 the processing unit 1202 is in data communication with a one or more machine readable storage (memory) devices which store instructions and/or data for controlling operation of the processing system 1200. In this example system 1200 includes a system memory 1206 (e.g. a BIOS), volatile memory 1208 (e.g. random access memory such as one or more DRAM modules), and non-volatile memory 1210 (e.g. one or more hard disk or solid state drives).

System 1200 also includes one or more interfaces, indicated generally by 1212, via which system 1200 interfaces with various devices and/or networks. Generally speaking, other devices may be integral with system 1200, or may be separate. Where a device is separate from system 1200, connection between the device and system 1200 may be via wired or wireless hardware and communication protocols, and may be a direct or an indirect (e.g. networked) connection.

Wired connection with other devices/networks may be by any appropriate standard or proprietary hardware and connectivity protocols. For example, system 1200 may be configured for wired connection with other devices/communications networks by one or more of: USB; FireWire; eSATA; Thunderbolt; Ethernet; OS/2; Parallel; Serial; HDMI, DVI; VGA; SCSI. Other wired connections are possible.

Wireless connection with other devices/networks may similarly be by any appropriate standard or proprietary hardware and communications protocols. For example, system 1200 may be configured for wireless connection with other devices/communications networks using one or more of: infrared; Bluetooth; Wi-Fi; near field communications (NFC); Global System for Mobile Communications (GSM), Enhanced Data GSM Environment (EDGE), long term evolution (LTE), wideband code division multiple access (W-CDMA), code division multiple access (CDMA). Other wireless connections are possible.

Generally speaking, and depending on the particular system in question, devices to which system 1200 connects—whether by wired or wireless means—include one or more input devices to allow data to be input into/received by system 1200 for processing by the processing unit 1202, and one or more output device to allow data to be output by system 1200. Example devices are described below, however it will be appreciated that not all computer processing systems will include all mentioned devices, and that additional and alternative devices to those mentioned may well be used.

For example, system 1200 may include or connect to one or more input devices by which information/data is input into (received by) system 1200. Such input devices may include keyboards, mice, trackpads, microphones, accelerometers, proximity sensors, GPS devices and the like. System 1200 may also include or connect to one or more output devices controlled by system 1200 to output information. Such output devices may include devices such as a CRT displays, LCD displays, LED displays, plasma displays, touch screen displays, speakers, vibration modules, LEDs/other lights, and such like. System 1200 may also include or connect to devices which may act as both input and output devices, for example memory devices (hard drives, solid state drives, disk drives, compact flash cards, SD cards and the like) which system 1200 can read data from and/or write data to, and touch screen displays which can both display (output) data and receive touch signals (input).

System 1200 may also connect to one or more communications networks (e.g. the Internet, a local area network, a wide area network, a personal hotspot etc.) to communicate data to and receive data from networked devices, which may themselves be other computer processing systems.

System 1200 may be any suitable computer processing system such as, by way of non-limiting example, a server computer system, a desktop computer, a laptop computer, a netbook computer, a tablet computing device, a mobile/smart phone, a personal digital assistant, a personal media player, a set-top box, a games console. [note repetition in computer processing system description]

Typically, system 1200 will include at least user input and output devices 1214 and a communications interface 1216 for communication with a network such as network 106 of environment 100.

System 1200 stores or has access to computer applications (also referred to as software or programs), i.e. computer readable instructions and data which, when executed by the processing unit 1202, configure system 1200 to receive, process, and output data. Instructions and data can be stored on non-transient machine readable medium accessible to system 1200. For example, instructions and data may be stored on non-transient memory 1210. Instructions and data may be transmitted to/received by system 1200 via a data signal in a transmission channel enabled (for example) by a wired or wireless network connection.

Applications accessible to system 1200 will typically include an operating system application such as Microsoft Windows®, Apple OSX, Apple IOS, Android, Unix, or Linux.

System 1200 also stores or has access to applications which, when executed by the processing unit 1202, configure system 1200 to perform various computer-implemented processing operations described herein. For example, and referring to the environment of FIG. 1 above, client system 104 includes a Data extraction application 112 which configures the client system 104 to perform the described client system operations. Similarly, Automated Check-In Server 102 includes a Server application 108 which configures the server system 102 to perform the described server system operations.

The flowcharts illustrated in the figures and described above define operations in particular orders to explain various features. In some cases, the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by different systems or applications.

Variations and modifications may be made to the parts previously described without departing from the spirit or ambit of the disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A data extraction system comprising a data extraction application, the data extraction application including a trained document classification model and computer program code which, when executed by a processor of an electronic device, causes the processor to:
present a user interface on the electronic device instructing a user to capture an image of a document;
submit the captured image of the document to the document classification model;
receive from the document classification model a document category value for the document;
process the document category value to select a next data extraction operation to be performed by the data extraction application; and
launch the selected data extraction operation.

2. A data extraction system according to claim 1, wherein the processor selects the next data extraction operation from a set of data extraction operations, the set comprising: presenting a retry user interface instructing the user to capture another image of the document; performing optical character recognition on the document, presenting a manipulation user interface instructing the user to physically manipulate the document; and presenting a successful extraction user interface informing the user of a successful data extraction from the document, wherein i) the manipulation user interface instructs the use sent another face of the document to the electronic device for capture; ii) the successful extraction user interface presents, on the electronic device, data extracted from the document, and includes a confirmation user interface element manipulable by the user to confirm that data extracted from the document is correct.

3-5. (canceled)

6. A data extraction system according to claim 2, wherein the computer program code further causes the processor to perform an image capture routine on the another face of the document once captured by the electronic device.

7. A data extraction system according to claim 2, wherein the computer program code further causes the processor to perform optical character recognition on the another face of the document once captured by the electronic device.

8. A data extraction system according to claim 2, wherein the manipulation user interface instructs the user to present another part of the same face of the document to the electronic device for capture.

9. A data extraction system according to claim 1, wherein the computer program code further causes the processor to:
input features of the document classification model as heuristics to a heuristic-filtering algorithm; and
execute the heuristic-filtering algorithm on the captured image prior to performing optical character recognition on the captured image.

10. A data extraction system according to claim 9, wherein the features of the document classification model include the presence of a machine-readable zone and the structure of the machine readable zone.

11. A data extraction system according to claim 1, wherein the data extraction application and the document classification model are comprised in a web application that is executable by a web browser installed on the electronic device.

12. A method for extracting data from a document, the method comprising:
delivering a data extraction application and a trained document classification model to an electronic device;
the data extraction application presenting a user interface on the electronic device instructing a user to capture an image of a document;
the data extraction application submitting the captured image of the document to the document classification model;
the data extraction application receiving from the document classification model a document category value for the document;
the data extraction application processing the document category value to select a next data extraction operation to be performed by the data extraction application; and
the data extraction application launching the selected data extraction operation.

13. A method according to claim 12, wherein the data extraction application selects the next data extraction operation from a set of data extraction operations, the set comprising: presenting a retry user interface instructing the user to capture another image of the document; performing optical character recognition on the document, presenting a manipulation user interface instructing the user to physically manipulate the document; and presenting a successful extraction user interface informing the user of a successful data extraction from the document.

14. A method according to claim 13, wherein the successful extraction user interface presents, on the electronic device, data extracted from the document.

15. A method according to claim 13, wherein the successful extraction user interface includes a confirmation user interface element manipulable by the user to confirm that data extracted from the document is correct.

16. A method according to claim 13, wherein the manipulation user interface instructs the user to present another face of the document to the electronic device for capture.

17. A method according to claim 16, wherein the data extraction application performs an image capture routine on the another face of the document once captured by the electronic device.

18. A method according to claim 16, wherein the data extraction application performs optical character recognition on the another face of the document once captured by the electronic device.

19. A method according to claim 13, wherein the manipulation user interface instructs the user to present another part of the same face of the document to the electronic device for capture.

20. A method according to claim 12, wherein the document extraction application:
inputs features of the document classification model as heuristics to a heuristic-filtering algorithm; and
executes the heuristic-filtering algorithm on the captured image prior to performing optical character recognition on the captured image.

21. A method according to claim 20, wherein the features of the document classification model include the presence of a machine-readable zone and the structure of the machine readable zone.

22. A method according to claim 12, wherein the data extraction application and the document classification model are comprised in a web application that is executable by a web browser installed on the electronic device.

23. A non-transient machine readable medium storing computer program code which, when executed by a processor of an electronic device, causes the processor to carry out the method according to claim 12.
